(19) United States
(12) Patent Application Publication
(10) Pub. No.: US 2010/0172759 A1
(43) Pub. Date: Jul. 8, 2010

(54) Retractable wind turbines

(76) Inventor: John T. Sullivan, Marriottsville, MD (US)

Correspondence Address: Lawrence S. Kramer, 14084 Big Branch Drive, Dayton, MD, 21036, US

(21) Appl. No.: 12/590,808

(22) Filed: Nov. 14, 2009

Related U.S. Application Data
(60) Provisional application No. 61/204,747, filed on Jan. 8, 2009.
(60) Provisional application No. 61/216,907, filed on May 22, 2009.

(51) Int. Cl. F03D 7/00

(52) U.S. Cl. 416/41; 416/31

(57) ABSTRACT

A wind turbine electrical generating device is described where the blades that comprise the airfoil are retractable during operation. This feature allows for a number of improvements over the current state of the art including damage protection and the ability to remain operational during high wind conditions. Further described is a computer feedback loop that controls the degree of retraction. In addition, lightweight airfoil turbine blades are described that are assembled from discrete segments.

### CROSS-REFERENCE TO RELATED APPLICATION

This application claims the priority of U.S. provisional applications 61/204,747 filed on Jan. 8, 2009 and 61/216,907 filed on May 22, 2009. both of which are incorporated by reference herein in their entirety.

### STATEMENT REGARDING FEDERALLY SPONSORED RESEARCH OR DEVELOPMENT

Not Applicable

### BACKGROUND OF THE INVENTION

Both horizontal and vertical axis wind turbines have been developed that display high efficiencies in converting wind power into electrical power. However there are several issues that are still being addressed to further improve performance in these devices. This invention addresses many of these issues including the ability to self start and the ability to continue operation in a high wind state in addition to improving the overall efficiency of the device. In addition, low cost manufacturing improvements and light weight methods are utilized to improve efficiency by design.

One limitation of wind turbines is often an effective way of protecting the device during periods of very high wind speed. Various braking devices and spoilers have been utilized to prevent harm to the turbine although they typically also take the turbine off-line resulting in a loss of production when the available power is the greatest. An embodiment of this invention utilizes an electronic feedback loop to partially collapse a vertical or horizontal wind turbine if the torque on the main shaft that turns the generator is above a critical level to keep a balance between wind speed and rated power output.

Wind turbines cannot typically handle the stresses induced by very strong winds and so braking systems are used to stop blade rotation and avoid damage. Alternatively, methods to collapse blades such as that described by Yum in U.S. Pat. No. 4,624,624 in which a hinged structure folds in automatically during high winds or that described by Traudt in U.S. Pat. No. 4,632,637 in which spring biased control mechanism folds blades out of harms way have been developed. In U.S. Pat. No. 4,818,181 Kodric teaches a spring that allows the wind turbine to move to a neutral position during strong winds. International publication WO 2008/104060 A1 describes a wind turbine where blades are collapsible on hinged support arms, but the retracted mode is for transport and erection and is not regulated by wind speed.

Methods have also been developed to actively control configurable wind turbine blades to account for different wind speeds. In U.S. Pat. No. 6,940,186 Weitkamp controls blades based on load feedback received from sensors mounted on the rotor blades and in U.S. Pat. No. 6,769,873 Beauchamp et al. configures wind turbine blades through actuators based on sensors measuring wind conditions. The present invention allows for the blades to collapse together based upon the rotating shaft torque feedback and continue to operate and generate power.

### BRIEF SUMMARY OF THE INVENTION

It is an object of this invention to provide for a wind turbine electrical generating device where the blades that comprise the airfoil are collapsible during operation. This feature allows for a number of improvements over the current state of the art. Having a collapsible feature protects the turbine from damage during very heavy wind conditions, and even can keep the turbine operational to reap the power benefits of high winds. Collapsibility also enables portability by allowing for a compact device when completely retracted. Control over the retraction mechanism can be via a computer controlled feedback loop, or by mechanical means that automatically react to wind speed variations.

To enable maximum portability and light yet strong construction, the airfoil blades of the collapsible wind turbines are constructed from attached segments. In an embodiment of this invention, hollow airfoil segments are connected and built up into a large airfoil. These segments could be made of moldable plastic or wrapped with thin metal or plastic airfoils over injection molded or cast metal airfoil spacers. In another embodiment, the segments are molded spars made of a polymer or metal and utilize an outer polymer, spray coated epoxy or urethane or PVC cloth cover to create an airfoil profile shape. In another embodiment, wing tips at the ends of the blades of vertical or horizontal wind turbines are used to prevent roll off for better efficiency and reduced noise.

It is another object of this invention that airfoil blade segments are connected via a swivel joint such that the through cables can allow the blade to flex in high winds without stressing the interface between segments. In another embodiment, the interface is shaped to provide an arc in the airfoil to allow the shape of the molded sail foils to create a C-shaped profile that can flex in the wind without the stresses of flat mating surfaces. In another embodiment of this invention, the stacking airfoil segments have mating interlocking male and female end caps to provide additional structural strength. In another embodiment of this invention the airfoil segments are hinged and cables run through the segments and allow the airfoils to bend in high winds. The hinged airfoils can also act as the frame to spin the generator. Another embodiment of this invention is a method of manufacturing airfoils by inserting tubing in the plastic mold of an airfoil before foam is added to stiffen the part and to allow a cable to pass through. This method effectively encapsulates the tubing, which may be comprised of metal, fiberglass, carbon, or other material, in the foam.

It is a further object of this invention to provide for an collapsible wind generator that utilizes a plurality of airfoil units that are each comprised of concentric circles. The individual spin on each of these units enhances the revolution of their attachment arms to a central rotating shaft that powers a generator.

It is a further object of this invention to provide for an improved wind generator with flexible blades that can be extended or retracted in the manner of an umbrella. When extended, the blades flex out such that the windmill has an overall spherical shape. The individual blades have an airfoil geometry. In one embodiment, the airfoil design is such that there is an integral flap which is open to catch the wind at low speeds and is pushed into a closed position during higher wind speeds. In another embodiment, a sail is included in the interior of the sphere to enhance low speed start up.

It is a further object of this invention to provide for a carousel arrangement of wind turbines, either with individual generators or a gearbox system to power a central generator. The carousel configuration puts the wind turbines away from the main shaft such that this moment arm gives an effective multiplier effect of the wind speed. Thus, even in low wind conditions, this arrangement generates electricity as if operating at a higher wind speed.

### BRIEF DESCRIPTION OF THE DRAWINGS

To improve the understanding of this invention, figures are provided to better describe examples of design and operation. These drawings represent examples of preferred embodiments but additional designs and operational conditions may also be included.

FIG. 1 shows a VAWT with an actuator mechanism to collapse the bracket that holds the airfoil blades.

FIG. 2 is the VAWT of FIG. 1 in the collapsed (high wind state) configuration.

FIG. 3 shows the mechanism that measures load and controls the position of an airfoil bracket (for VAWT) or blades (HAWT).

FIG. 4 is a HAWT with a spring mechanism to collapse the blades.

FIG. 5 is a detail view of the HAWT of FIG. 4.

FIG. 6 is a HAWT with an actuator mechanism to collapse the blades.

FIG. 7 is a VAWT collapsible by pulleys and cables.

FIG. 8 is a detail view of the mechanisms of FIG. 7.

FIG. 9 shows the VAWT of FIG. 7 in the retracted position.

FIG. 10 is a wind turbine similar to FIG. 7, but with additional airfoil blades.

FIG. 11 is a HAWT carousel.

FIG. 12 is a HAWT carousel with a Savonius type start up mechanism.

FIG. 13 is a VAWT carousel

FIG. 14 is a collapsible wind turbine utilizing counter weights.

FIG. 15 shows the turbine of FIG. 14 in the retracted position.

FIG. 16 is an airfoil with four blades, each comprised of a pair of wheel type airfoils.

FIG. 17 shows the airfoil of FIG. 16 in the retracted position.

FIG. 18 is a collapsible wind turbine comprised of multiple airfoil blades and interior sails in the extended, spherical position.

FIG. 19 is a collapsible wind turbine with two stacked assemblies, each comprised of multiple airfoil blades in the extended, circular configuration.

FIG. 20 is an airfoil blade used for the HAWTs.

FIG. 21 shows a ribbed hollow segmented airfoil blade with through rods and cables.

FIG. 22 is an airfoil blade constructed from two halves.

FIG. 23 shows a curved segmented airfoil.

FIG. 24 shows a portion of a fingerjoint segmented airfoil.

FIG. 25 is an airfoil blade made of bulkheads, cables and an outer fabric.

FIG. 26 shows the construction mechanism of FIG. 25

FIG. 27 is a flexible blade wind turbine

### DETAILED DESCRIPTION OF THE INVENTION

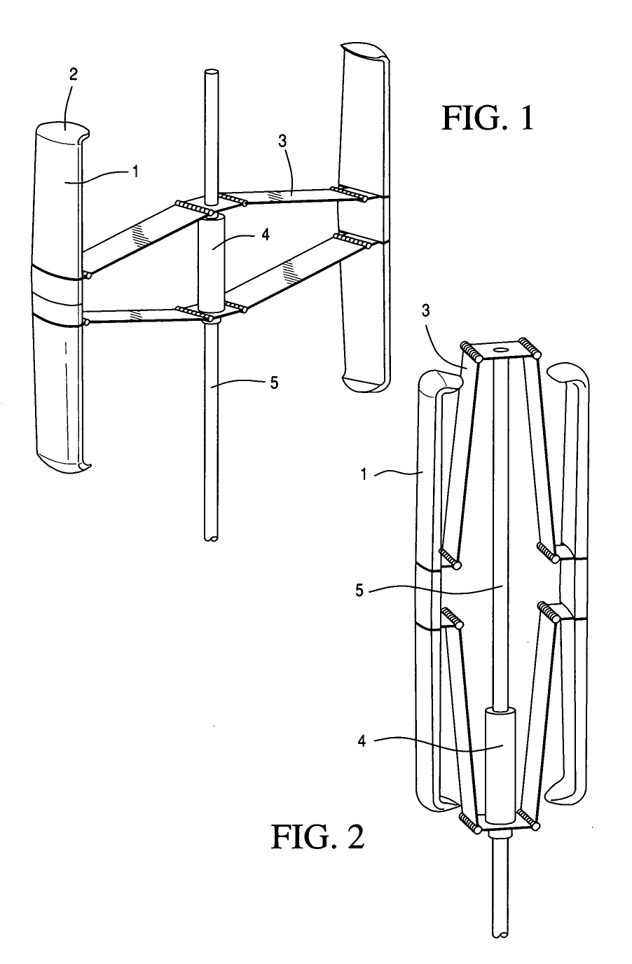

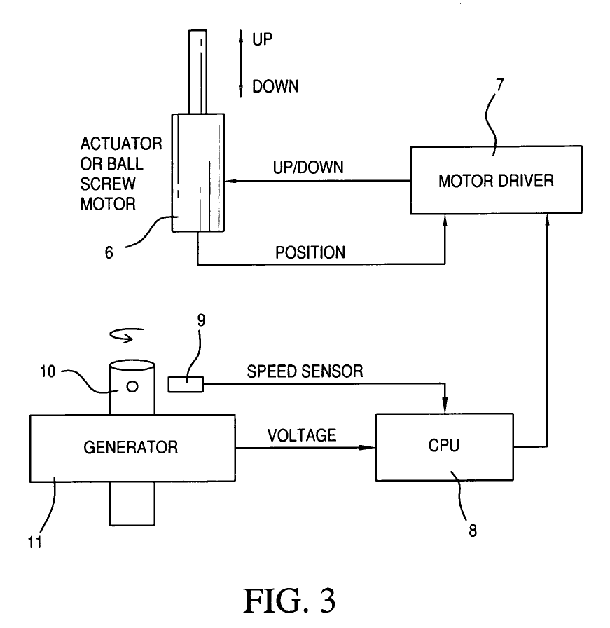

FIG. 1 shows one embodiment of this invention. In this embodiment a VAWT is built from blades comprised of segments 1 and with wing tips 2. The blades are attached by a bracket 3 that envelopes an actuator 4 that slides on the central shaft 5. The actuator moves to extend or retract the bracket depending upon wind conditions and is controlled by a torque sensor on the main shaft in a feedback loop described in FIG. 3. This type of system can also be used for VAWTs with single piece blades or without wingtips or with a different number of total blades. FIG. 2 shows the turbine during a high wind state as the actuator 4 has moved down the central shaft 5 causing the hinges on the bracket 3 to retract the blades. This retracted position protects the turbine from damage at high wind speeds yet enables it to continue spinning and supplying the generator with energy. Most wind turbines cannot operate at high wind speeds due to centrifugal forces that are damaging to the mechanical system and thus are turned off and are not able to take advantage of the high power output that high winds could generate

FIG. 3 is another embodiment of this invention that is a schematic of the mechanism used to control the shape of the turbine. Either an actuator or ball screw motor 6 moves up or down as controlled by the motor driver 7 which in turn receives a signal from the central processing unit (CPU) 8. The CPU receives input from the speed sensor 9 that monitors the torque of the central shaft 10 that powers the generator 11. In this way the extension of the turbine blades is able to constantly be at the optimum position through this monitor-feedback-control loop. With the control system described here, the turbines can still operate efficiently in a partially collapsed configuration during moderately high winds and can still spin and power the generator when fully collapsed if necessary. Actuators or springs mounted on the main shaft are used as torque measuring and control devices for either vertical or horizontal wind turbines and are utilized in a computer controlled closed loop feedback.

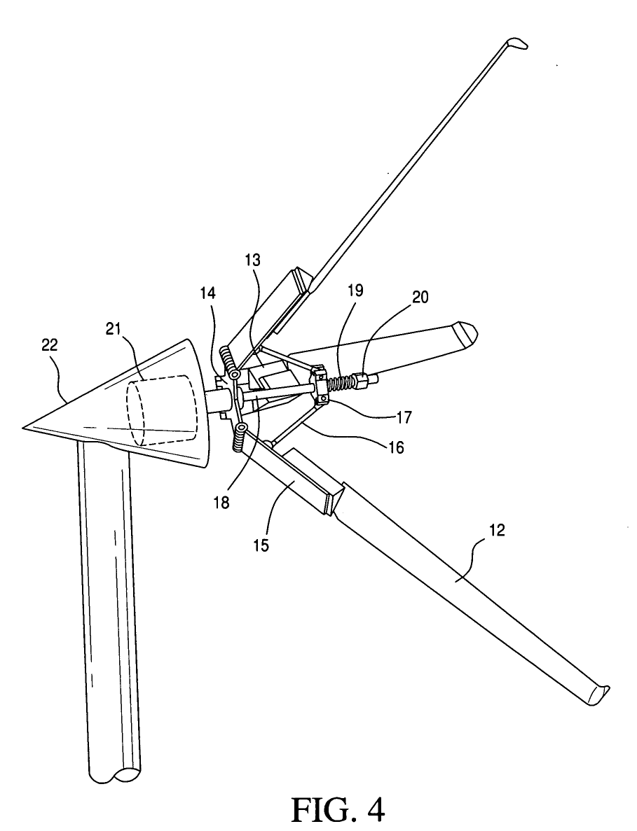

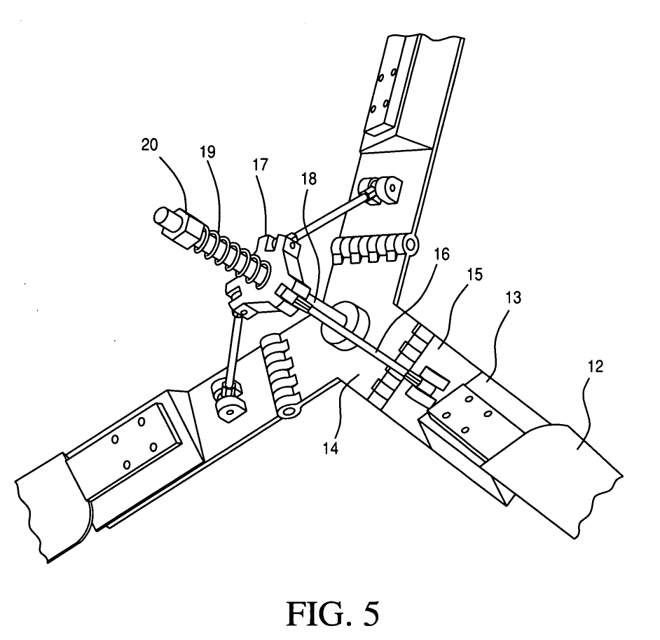

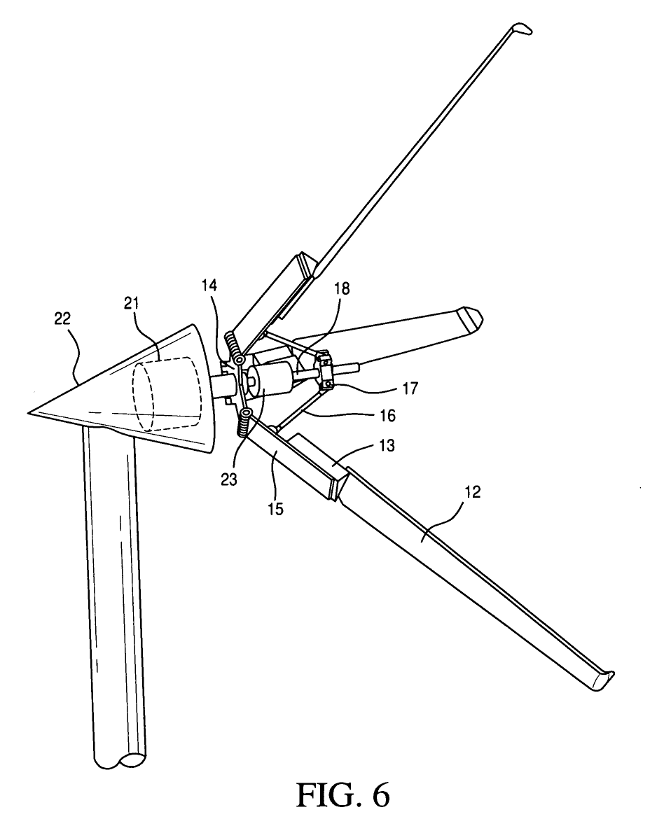

FIG. 4 is another embodiment of this invention showing a three bladed HAWT that uses a mechanical control mechanism. Each blade 12 is attached to an angled blade mount 13 and the three spoked hub 14 is attached to the blade holder by a hinged blade base 15. A rod 16 connects each blade holder to a hub 17 that can slide on the central shaft 18. Atop the hub is a spring 19 contained by a nut 20 that is used to monitor and control the position of the blades based upon the wind speed. During periods of high wind, the spring will compress and collapse the blades to a smaller spin diameter protecting them from damage yet allowing the wind turbine to generate electricity during high winds. The shaft drives the generator 21 that is covered by a housing 22. FIG. 5 shows more detail of this HAWT with a clearer view of the spring 19 that is used to monitor and control the extension or retraction of the blades as it moves the hub 17 up or down the central shaft 18. Another embodiment is shown in the HAWT of FIG. 6 where instead of a spring mechanism, an actuator 23 is used to monitor the torque of the central shaft 18 and control the disposition of the blades 12. The actuator is controlled by the feedback loop described earlier in FIG. 3.

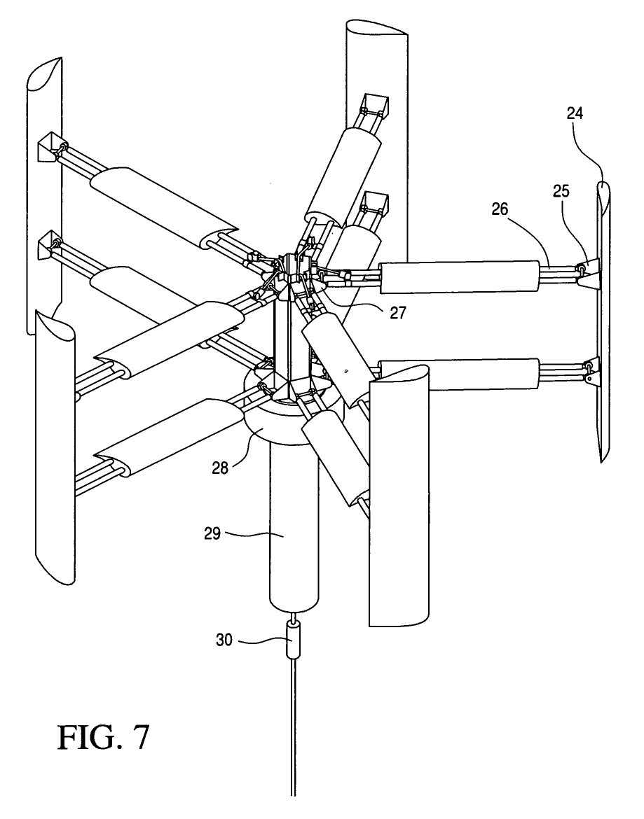

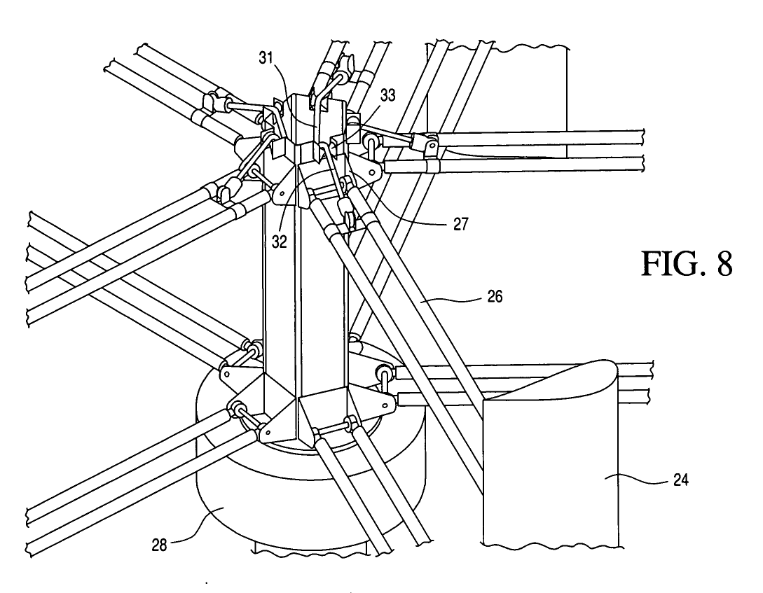

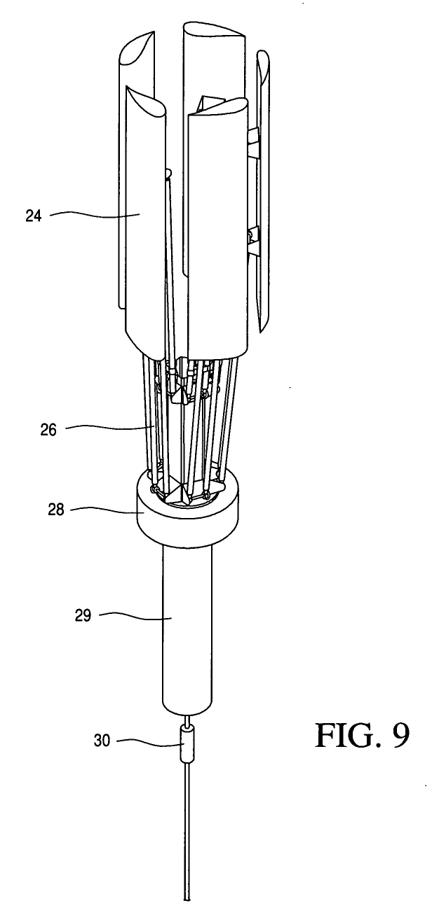

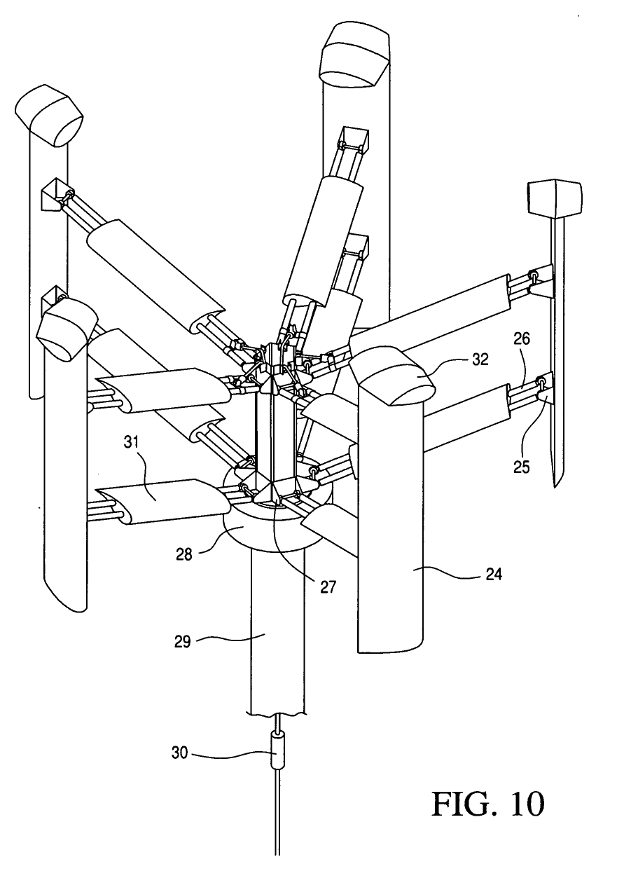

FIG. 7 shows a VAWT with five airfoil blades 24 that are mounted by brackets 25 and connecting rods 26 to brackets on the central shaft 27. The generator 28 is powered by the rotation of the central shaft 29. This view is in the fully operational position. Finer detail is shown in FIG. 8 where the connection between the airfoil blades 24 by connecting rods 26 to the brackets on the central shaft 27 are by a cables 31 connected by cable hinges 32 between the rods. The cables go over cable guides 33 down the central shaft and to a swivel joint 30 (shown in FIG. 7) that prevents entanglement of the cables from the spinning wind turbine and connects to a crank or motor driven actuator (not shown) that receives wind speed information from a shaft torque sensor and controls the length of the cable to open and close the turbine as per the control feedback loop described earlier. Even in the fully collapsed position of FIG. 9, the airfoil blades 24 remain vertical and operational. The connecting rods 26 are now almost vertical as the cables have been tensioned. FIG. 10 is a collapsible VAWT but with some horizontal airfoil blades for better efficiency. The vertical airfoild blades 24 have brackets 25 that are used to connect rods 26 to brackets on the central shaft 27. A collar 28 controls the position or amount of collapse by moving up or down the central shaft 29. In this configuration, additional horizontal airfoil blades have been added between the vertical blades and central shaft such that the connecting rods run through them 31, and another set has been added atop the vertical blades 32. These horizontal blades provide for both drag for easier start up, and additional lift during normal operation.

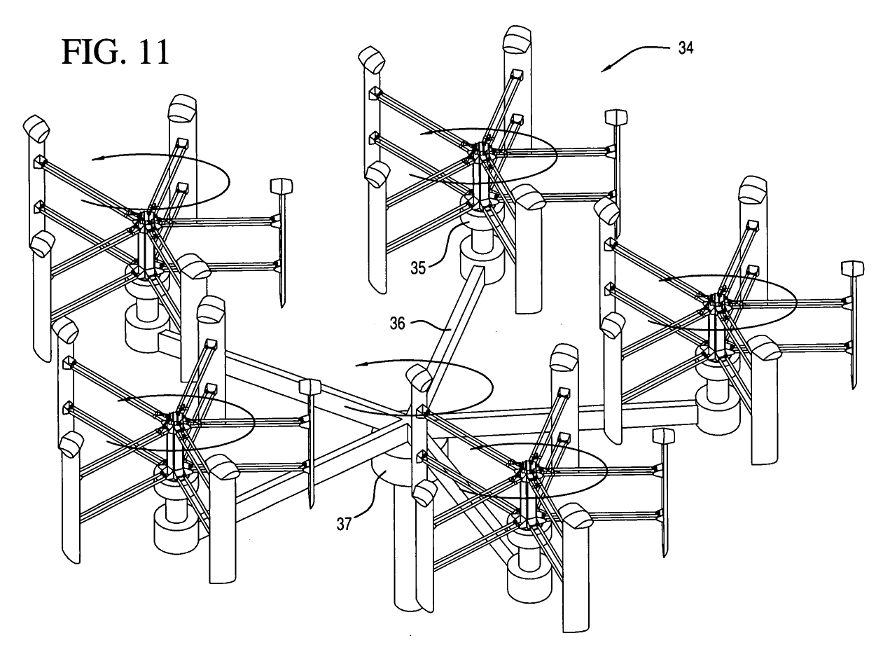

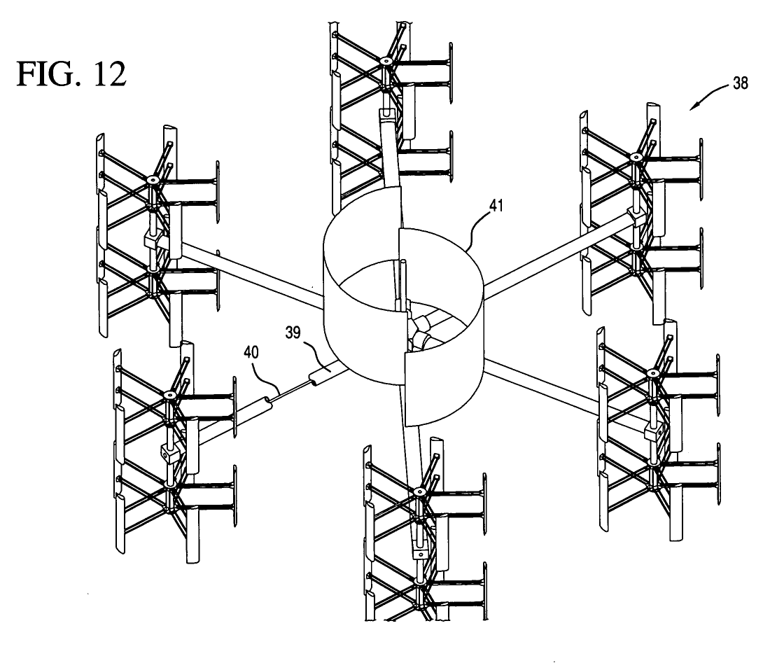

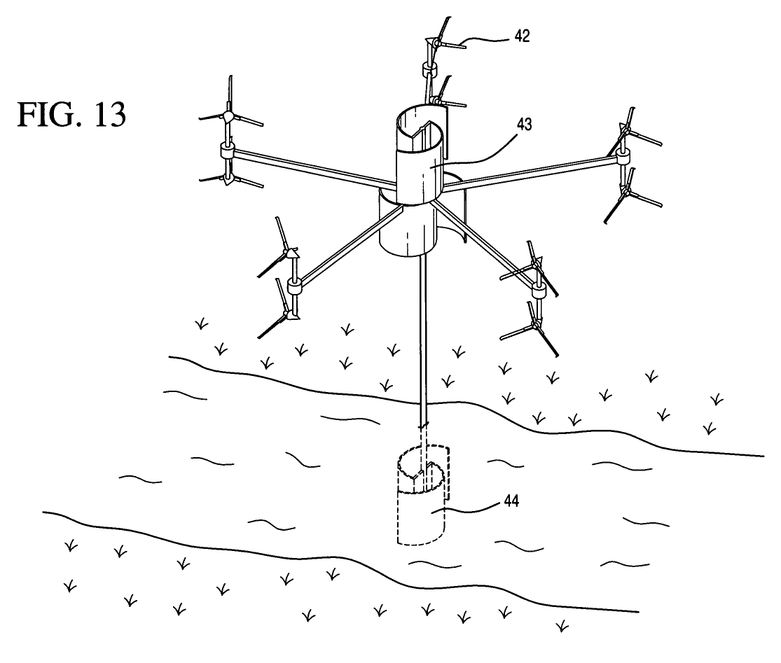

FIG. 11 is carousel of horizontal axis wind turbines. Each turbine 34 has a separate generator 35 and in addition to spinning, the entire carousel rotates and the connecting rods 36 spin the main shaft and power the central generator 37. Perhaps the best advantage of a carousel system like this is to take advantage of the additional rotational speed possible for the main shaft coming from the long moment arms of the individual turbines thus providing a multiplying effect of the actual wind speed. FIG. 12 is another example of a carousel arrangement. In this configuration the individual turbines 38 each have a gearbox and are connected to the main shaft by connecting rods 39 with an internal drive 40 that powers a single central generator. This design also shows an optional Savonius type central drag mechanism 41 to improve efficiency at start up. FIG. 13 is an example of a carousel arrangement with vertical axis wind turbines 42. This example also shows the optional Savonius central mechanism 43. While this configuration could be used on land, the example in the figure shows a further Savonius mechanism underwater 44 to provide additional power to the generator.

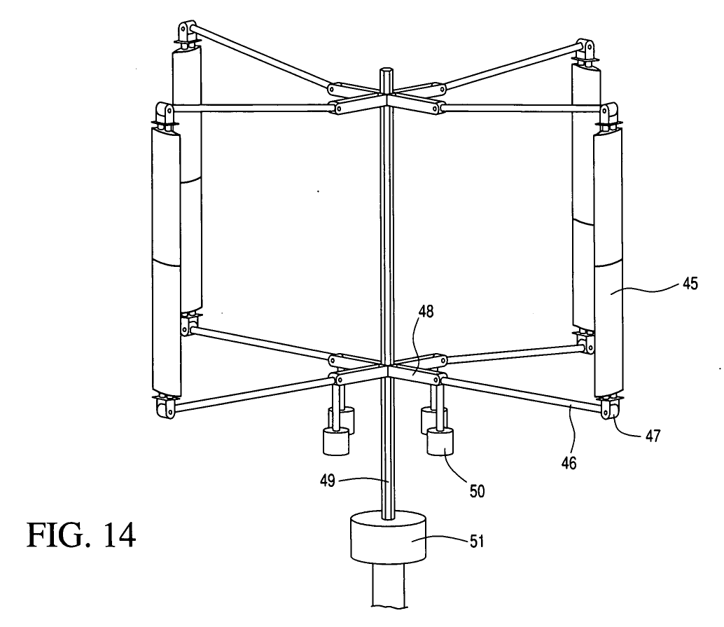

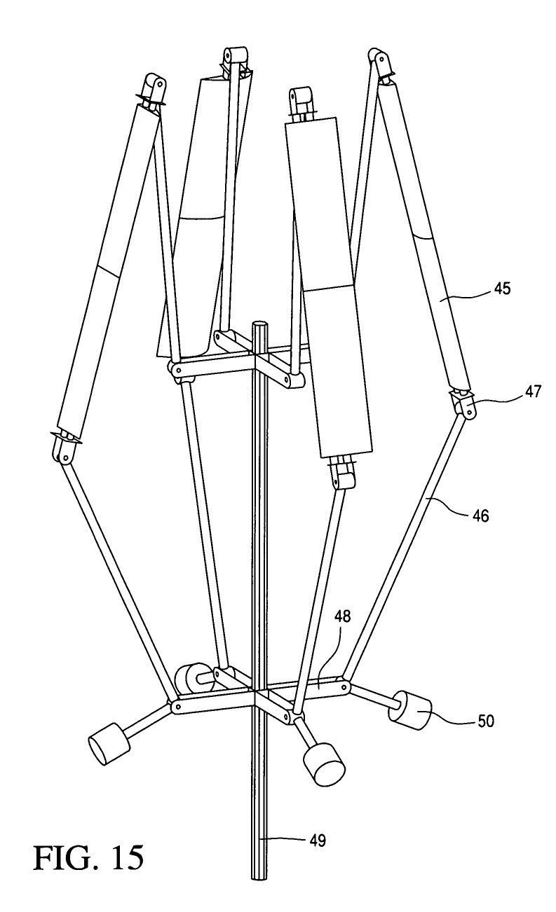

FIG. 14 is an example of a collapsible wind turbine that is controlled by purely mechanical means. Vertical segmented airfoil blades 45 are connected via rods 46 by an attachment means at both the top and bottom of the blades 47 and the rods are attached to a spoked hub 48 on the central shaft 49. Weights 50 are also connected to the spoked hub and control the level of retraction of the mechanism. In a very high wind state, shown in FIG. 15, the weights 50 are forced outward as the turbine spins, increasing their effective force and pulling the lower spoked hub 48 down the central shaft 49, effectively collapsing the wind turbine. As the wind dissipates, the weights will again travel inwards, lessening the retraction and thus providing a mechanical means of self regulation.

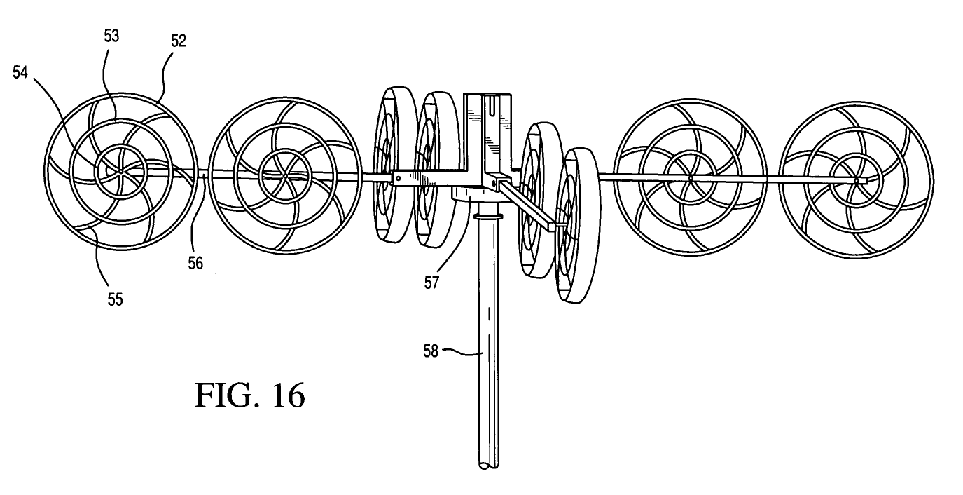

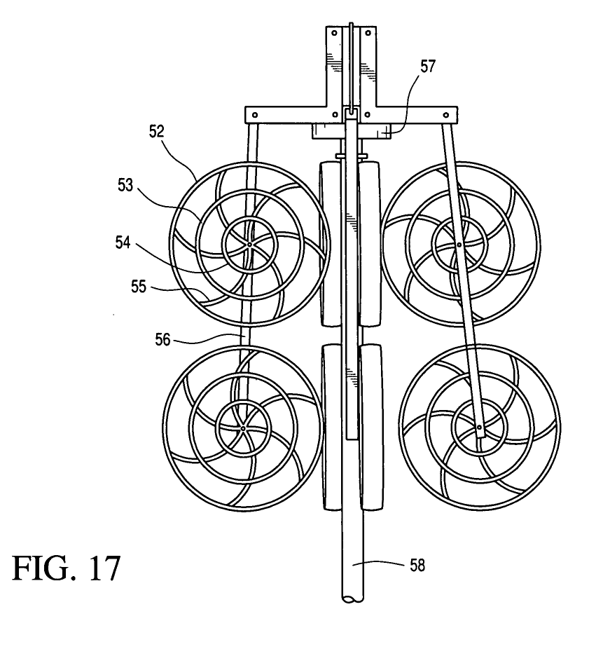

Another wind generator comprised of multiple circular airfoil units is shown in FIG. 16. Each circular airfoil is comprised of a wheel shaped airfoil comprised of an outer 52, a middle 53 and an inner 54 concentric airfoil circle and arced airfoil spokes 55. Each unit is then mounted on an arm 56 that connects with a central hub 57 that transmits power to the central rotating shaft 58. The number of units could be varied but in this example, four sets of two are used. In this embodiment, the arms can hold the units at right angles to the central shaft, but as shown in FIG. 17 this wind generator could be collapsed to a portable position. In this figure the circular airfoils are shown retracted on their connecting arms.

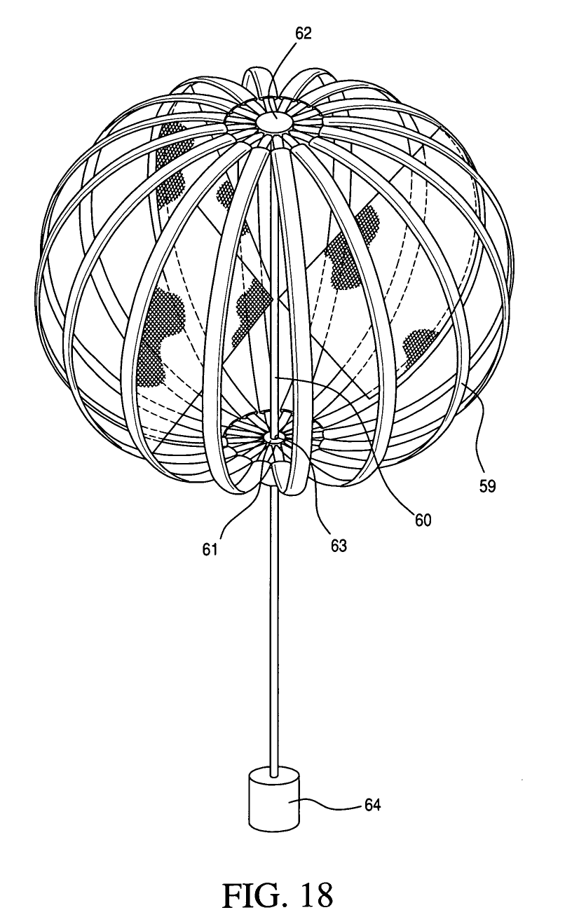

FIG. 18 shows another embodiment of this invention where the wind turbine is comprised of an assembly of multiple flexible airfoil blades 59. The blades are flexed such that the assembly is spherical, although the blades could also be collapsed down around the central shaft 60 for portability. Each blade is attached to a floating hub at the bottom 61 and a fixed hub at the top 62, and can be fixed in place by a pin 63 in the central shaft. The large surface area and long blade length of the airfoils should allow this assembly to start in low wind speeds, however optional interior sails are also useful to catch the wind for start up. Once the assembly starts to spin centrifugal forces will stretch it into a larger shape supplying an increased mechanical torque to power the generator 64.

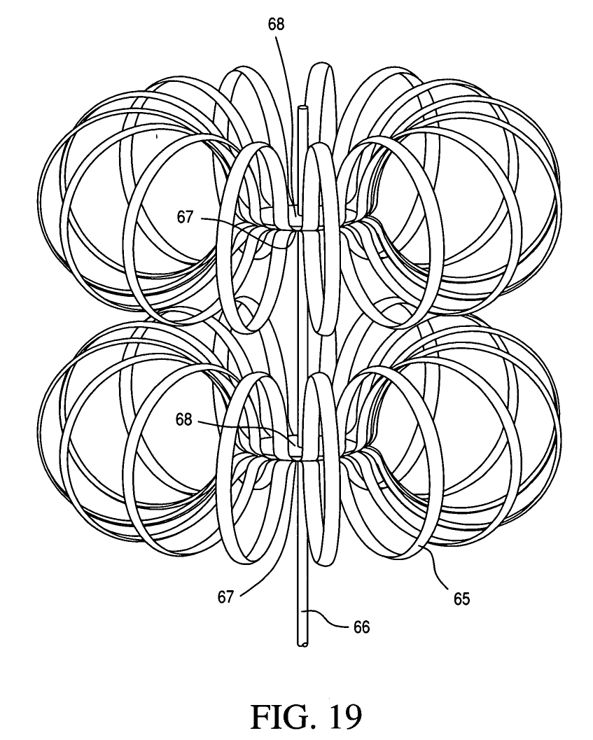

FIG. 19 is a wind generator similar to that of FIG. 18 except that there are two sets of blades. Each blade 65 is attached to the central rotating shaft 66 by a lower floating hub 67 that has been slid up to contact the fixed hub 68 for each set of blades, thus forcing each flexible blade into a circular configuration.

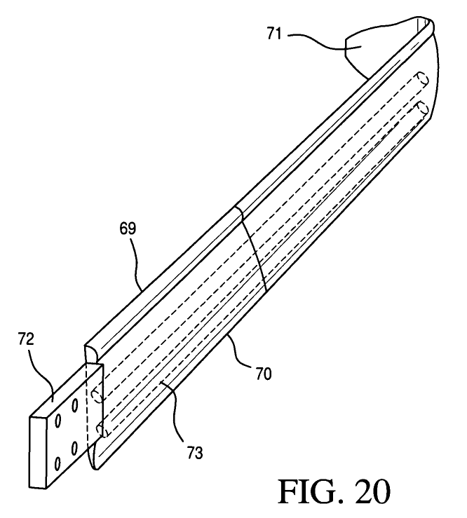

FIG. 20 shows the detail of an airfoil blade for a collapsible HAWT or VAWT of this invention. These blades are are true airfoils with a leading edge 69 and a trailing edge 70. In a preferred embodiment the blades also have wingtips 71 to further enhance performance. These blades are attached to the turbine via a mounting plate 72. These blades can be made from lightweight material in segments and contain internal stiffening rods 73. These type of wind turbine blades are very portable, yet strong and stiff. Most large airfoils are manufactured from expensive composites, fiberglass or heavier metals that can overburden the frame design. The airfoils described in this invention may be manufactured from low cost lightweight polymers and would thus be more easily transported and assembled. The airfoils can be foam filled and inserted with metal tubes for additional strength.

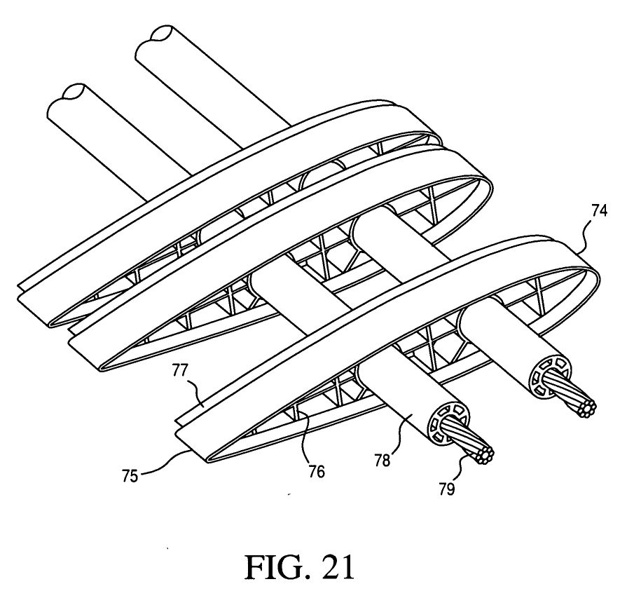

In another embodiment of this invention the configuration and structure of lightweight airfoil wind turbine blades and their construction method is provided. FIG. 21 shows an airfoil constructed from individual segments. Each segment is the shape of an airfoil with a leading edge 74 and a trailing edge 75. The segment is constructed from a lightweight material and is essentially hollow with interior stiffening ribs 76 for structural integrity. One side of each segment has a narrower connector tab 77 that fits into the next segment to mechanically lock the segments together to form a longer airfoil blade. In this example, the blade is further stiffened by through rods 78 and strengthened by through cables 79. This approach to wind turbine blade construction allows for easier transportability than that of large individual piece blades and the flexibility to allow for blades of different lengths as required. The lightweight nature of the blades also reduces stresses on the wind turbine assembly and can thus improve the service life. The through stiffeners can utilize oversized extruded plastic or metal cable bearings to reduce stress on the lightweight polymer from the metal cable. The plastic airfoil floats freely on the metal cables and the cables act as the framework that transfers kinetic energy into rotational power with very little stress on the plastic.

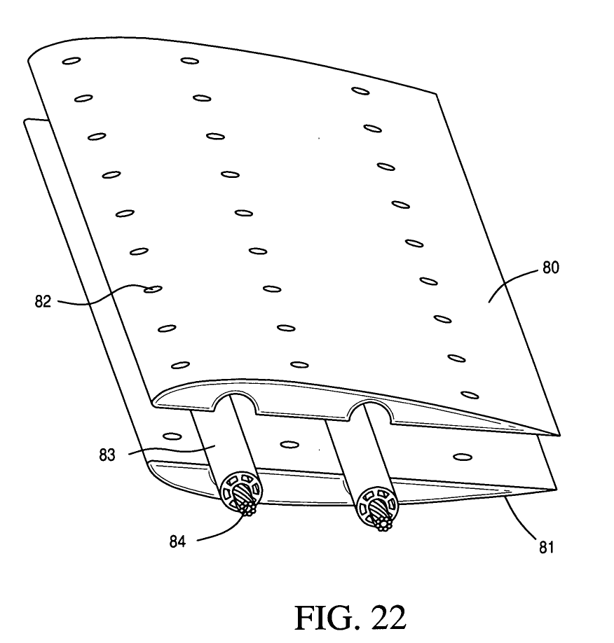

In another embodiment, FIG. 22 shows an airfoil constructed of segments that are configured as an upper half 80 and a lower half 81 with holes 82 and through rods 83 and through cables 84 for stiffening and strengthening. The holes are included to accommodate rivets or fasteners that join the two segments together. By having a hemisphere in each half airfoil, the blade is stiffened and the hole dimension can be held to a tighter tolerance than by later cutting a hole through a thin skin in a whole airfoil. In other embodiments, the segmented blades described may be strengthened by cables alone, without through rods thus allowing the blades to flex during operation. In addition, the mechanical fastening of the segments may be improved by the use of adhesives or additional locking mechanisms.

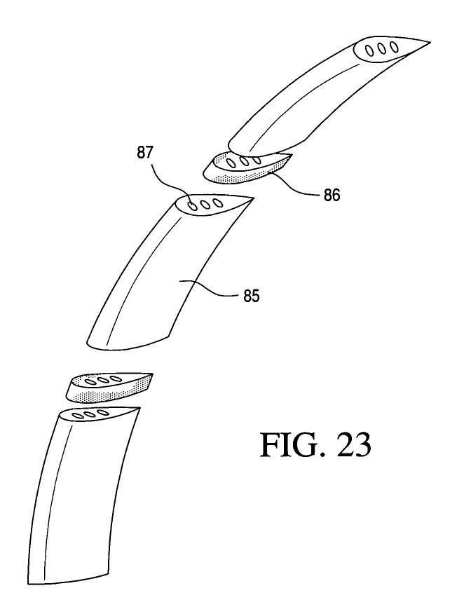

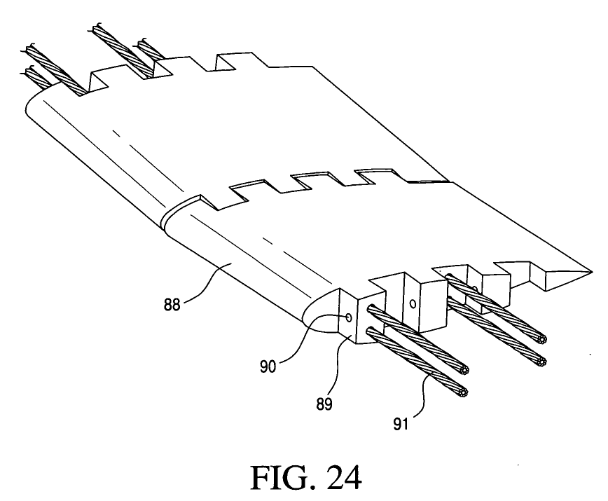

In FIG. 23, a curved blade is fabricated from curved blade segments 85 with connecting segments 86 that would be made from a more compliant material. The blade can then be stiffened or strengthened by inserting rods or cables through the holes 87 in the blade. In another preferred embodiment, FIG. 24 is an example of another flexible wind turbine blade constructed from individual segments. Each blade segment 88 has finger joints 89 on each end that interlock with the adjacent segment. Holes 90 through the finger joints allow for a fastening rod to lock the segments together and cables 91 through the blade increases the overall strength while preserving flexibility.

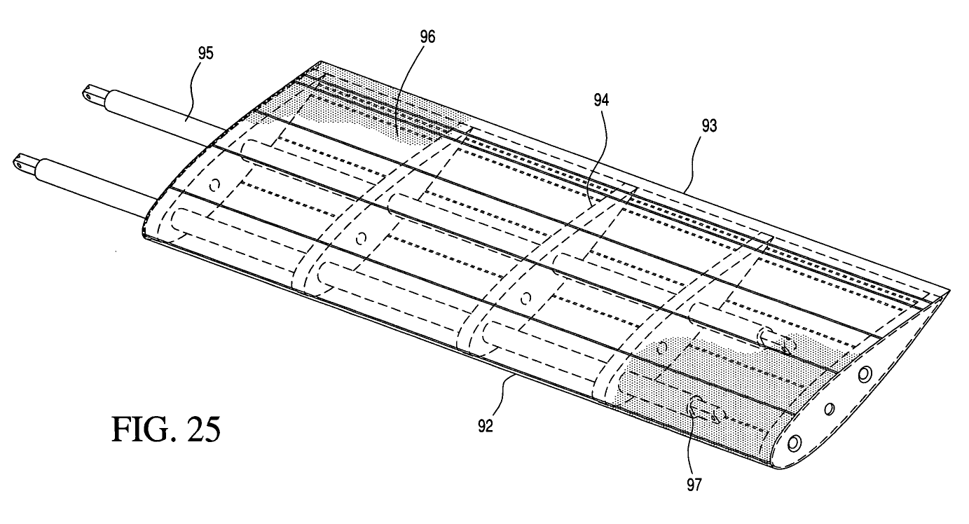

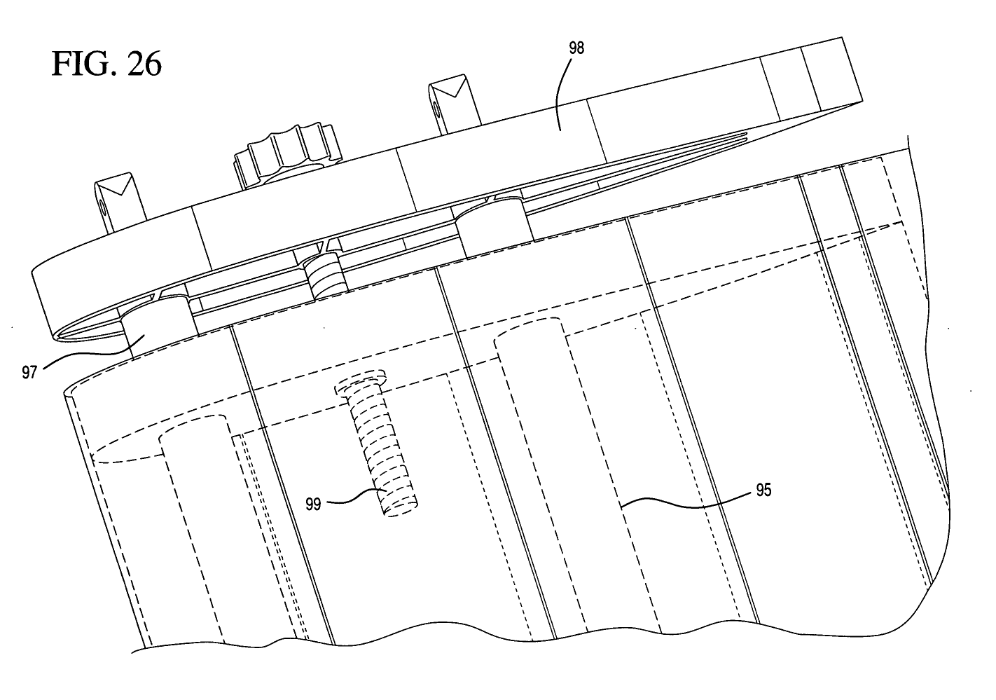

FIG. 25 is another blade design with a leading edge 92 and a trailing edge 93. The construction is by multiple cross-member bulkheads 94 and stiffening through rods 95 and a fabric cover 96. This airfoil blade can be easily collapsed by removing the rods to provide for portability. In this manner, large airfoil blades can be set up on site and can be lightweight and strong. FIG. 26 shows the mechanism that holds this type of collapsible blade together. The through rod diameter steps down 97 and stops against a similar diameter step in the endcap 98 as a mechanical stop so that when the bolt 99 is tightened, the outer fabric 97 is pulled tight and the blade assembly is strong and secure. Other methods of securing the through rod to the end cap may also be used to ensure a tight, stiff structure when the bolt is tightened.

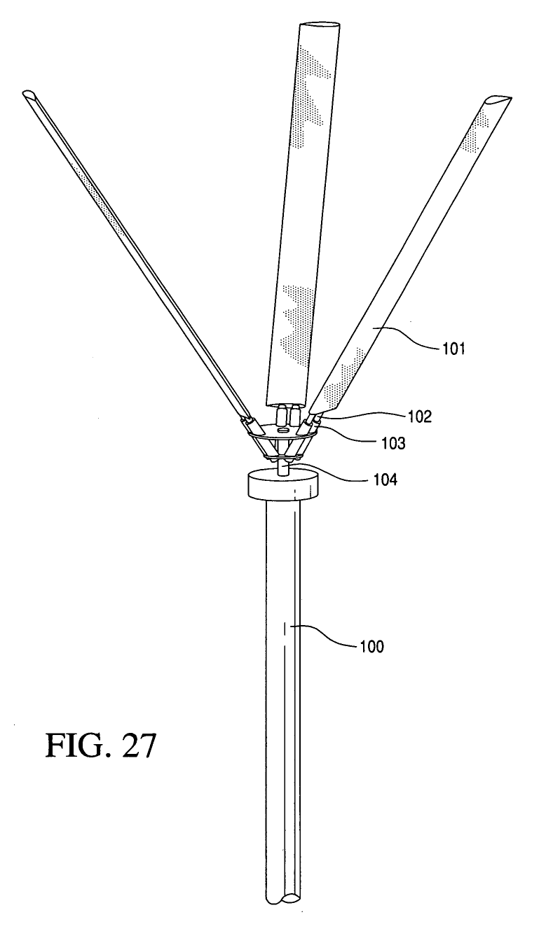

FIG. 27 is an example of a flexible blade wind turbine with airfoil that mounts on a pole 100. The airfoil blades 101 are made of a flexible material so that they will flex in the wind and yet still be operational at even high wind speeds. The blades have pegs 102 at the bottom which sit in a holder 103 that is connected to a central rotating shaft 104 that powers the generator. Alternatively, the rigid holder may be replaced by a spring mechanism that could allow the blades to collapse all the way down to the pole.

1. An energy generating wind turbine comprising a plurality of airfoil shaped blades and a central rotating shaft in which said blades are retractable to a smaller sweep diameter and the degree of retraction is determined by the position of a floating hub on said central shaft of said wind turbine; wherein said blades are connected to said floating hub by support arms.

2. The wind turbine of claim 1 that is a vertical axis wind turbine such that said airfoil blades are essentially parallel to said central shaft and are mounted by hinged support arms to a floating hub on said central shaft; said floating hub can be moved up or down said central shaft to cause a retraction or extension of said support arms and effect a decrease or increase in the sweep diameter of said airfoil blades as they spin in response to wind.

3. The wind turbine of claim 1 that is a horizontal axis wind turbine such that said airfoil blades are connected together by a central fixed hub and extend radially out from a central point and by support arms mounted to a floating hub that is mounted on a central shaft; said floating hub can be moved up or down said central shaft to cause a retraction or extension of said support arms and effect a decrease or increase in the sweep diameter of said airfoil blades as they spin in response to wind.

4. The wind turbine of claim 1 in which the position of said floating hub is controlled by an actuator or ball screw motor that responds to a wind speed or torque sensor.

5. The wind turbine of claim 1 in which the position of said floating hub is controlled by a spring mechanism fixed onto said central shaft by a nut wherein said spring mechanism is compressed during high wind speeds such that the blades of the wind turbine are retracted in proportion to the degree of compression of said spring.

6. The wind turbine of claim 1 in which said plurality of airfoil blades form a spherical outline when fully operational and the operational position is maintained by a lock pin in the central shaft that fixes the position of said floating hub.

7. The wind turbine of claim 6 that is further comprised of fabric sails in the interior of said spherical assembly.

8. The wind turbine of claim 6 in which there are multiple spherical outlines, each comprised of a plurality of airfoil blades located on the same main shaft.

9. An energy generating wind turbine comprising a plurality of airfoil shaped blades connected to support arms connected by pivot joints to fixed hubs on a central rotating shaft in which said blades are retractable to a smaller sweep diameter and the degree of retraction is determined by mechanical means that effect the angle of said support arms.

10. The wind turbine of claim 9 in which said mechanical means is comprised of a series of cables and pulleys that are attached to said support arms and run down the central shaft into a swivel joint, from which a single cable exits and the tension on the cable and thus the position of said support arms and blades is controlled by a wind speed or torque sensor.

11. The wind turbine of claim 9 in which said mechanical means is comprised of a series of weights that are attached by a pivot joint to the lower end of said support arms such that said weights increase their sweep diameter as the wind speed increases causing said support arms to retract said airfoil blades and the opposite effect of decreasing the weights sweep diameter and extending of said airfoil blades occurring during lower wind speed conditions.

12. The wind turbine of claim 9 in which said airfoil blades are circular or wheel shaped and multiple wheel shaped blades are fixed to each of said support arms.

13. The wind turbine of claim 9 that is further comprised of a plurality of said wind turbines, where each wind turbine is equidistant from a main shaft and is associated with an individual electrical generator and mounted on a spoked hub that also rotates said main shaft that drives a central electrical generator.

14. The wind turbine of claim 9 that is further comprised of a plurality of said wind turbines, where each wind turbine is equidistant from a main shaft and is associated with a gear box and mounted on a spoked hub that also rotates said main shaft that drives a central electrical generator.

15. The wind turbine of claim 9 that is further comprised of a plurality of said wind turbines, where each wind turbine is equidistant from a main shaft and is further comprised of a drag-inducing mechanism on said central shaft to facilitate start-up.

16. The wind turbine of claim 9 that is further comprised of a plurality of said wind turbines, where each wind turbine is equidistant from a main shaft and is further comprised of an airfoil blade mounted on said main shaft, below said plurality of wind turbines and immersed in a body of water to act as an auxiliary hydrofoil to augment the rotation of said main shaft and thus generate additional electrical power.

17. The wind turbine of claim 10 in which said cable that exits from the swivel joint is controlled by mechanical means such as a take up reel or spool.

18. The wind turbine of claim 10 that is further comprised of horizontal airfoils atop said blades and horizontal airfoils mounted on said support arms.

19. An computer controlled feedback loop to control the position of a retractable energy generating wind turbine comprised of
a wind speed sensor that monitors the torque of the central shaft of said wind turbine and sends a signal with this information to
a central processing unit (CPU) that processes this information and sends a signal to a motor driver that controls the position of
an actuator or ball screw motor that moves up or down the central shaft positioning a floating hub that is connected to the blades of said wind turbine causing extension or retraction of said blades in response to current wind conditions.

20. Airfoil shaped blades for use in energy generating wind turbines that are produced by joining discrete segments such that the individual segments are easily transported and assembled and are possible to mass produce at low cost and from lightweight materials.

21. The blades of claim 20 wherein said blade segments are comprised of a plurality of evenly spaced airfoil shaped bulkheads that define the shape of the airfoil through which rods run the length of the blade and the exterior is covered by a fabric such that when the rods are removed from the interior, the blade can be collapsed for transport.

22. The blades of claim 20 wherein said segments are each in the shape of an airfoil with a leading and trailing edge and are essentially hollow save for stiffening members and the assembled turbine blades are stiffened and strengthened by rods and or cables that are inserted through passageways in said internal stiffening members and run through the length of the assembled blade.

23. The blades of claim 20 where said hollow blades are filled with foam.

24. The blades of claim 20 wherein said blades are suitable for use in collapsible wind turbines

25. The blades of claim 20 that are further comprised of wing tips at the ends of said blades.

26. The blades of claim 20 where said blade segments are each in the shape of half of an airfoil such that they contain an airfoil surface and the centerline of the airfoil such that when assembled the segments form a full airfoil shape and said assembled airfoil is further stiffened and strengthened by rods and or cables that run through the length of the assembled blade through holes designed into the segments.

27. The blades of claim 20 where said blade segments are curved along their length and during construction a shorter segment made from more compliant material is inserted in between said curved segments such that the assembled airfoil blade displays flexibility in the wind.

28. The blades of claim 20 where said blade segments have stepped edges such that they fit together in a fingerjoint pattern.

29. An energy generating wind turbine comprising a plurality of airfoil shaped blades that are manufactured from a material that allows said blades to flex in the wind, and said blades are mounted on one end to a central hub that connects to a central rotating shaft, and said blades extend outward from said central rotating shaft.

30. The wind turbine of claim 29 wherein said central hub also acts a a spring mechanism such that said blades can fully flex and open or retract such that they have a full 180 degrees of movement from being folded in upon each other to being essentially parallel with said central rotating shaft.
